(19) United States
(12) Patent Application Publication
(10) Pub. No.: US 2008/0129637 A1
(43) Pub. Date: Jun. 5, 2008

(54) DUAL-BAND LOOP ANTENNA

(76) Inventors: Yun-Wen CHI, Sinjhuang City (TW); Kin-Lu Wong, Kaohsiung City (TW)

Correspondence Address: SINORICA, LLC, 528 FALLSGROVE DRIVE, ROCKVILLE, MD, 20850, US

(21) Appl. No.: 11/564,893

(22) Filed: Nov. 30, 2006

(51) Int. Cl. H01Q 1/38; H01Q 7/00

(52) U.S. Cl. 343/866; 343/700 MS

(57) ABSTRACT

A dual-band loop antenna comprising: a grounding plane, a radiation metallic loop and a radiation metallic plate, the shape of the grounding plane is generally rectangular having a grounding point and a shorting point; the radiation metallic loop has a feeding end and a shorting end, the shorting end is electrically connected to the shorting point on the grounding plane; while the radiation metallic plate is encircled by the radiation metallic loop, and one terminal point of the radiation metallic plate is electrically connected to the vicinity of the shorting end of the radiation metallic loop. The embodiments of antennas of the present invention suit designing of antennas for mobile phones using the bands of GSM (890˜960 MHz)/DCS (1710˜1880 MHz).

### BACKGROUND OF THE INVENTION

1. Field of the Invention

The present invention relates to a loop antenna, and especially to a dual-band loop antenna that is suitable for being built in a mobile phone.

2. Description of the Prior Art

Following the fast development of wireless communication, among the wireless communication products, antennas take an important role; especially under a tendency of being light, thin and small, the height of an antenna will influence the value of a product, such wireless communication products mainly and mostly are designed as planar antennas or exposed monopole antennas. The heights of planar antennas for conventional dual-band mobile phones are about 7-10 mm; when the technique of such a conventional planar antenna is used on a thin mobile phone (the thickness of the mobile phone is about 10 mm or shorter), a problem of having overly large height exists and is unable to really satisfy the requirement of thinning of the mobile phone. Manufacturers in solving such a problem mostly turn to adopt the designing technique of monopole antenna; by virtue that exposed monopole antennas protruding out of grounding planes are less affected by the grounding planes, thicknesses can be reduced to get the object of applying on thin mobile phones. However, whichever of the planar antennas and the monopole antennas are used, by the limited internal spaces available for designing of the mobile phones, GSM bands normally can only exactly cover the bands applied, when the environment of using is changed, for instance, a user holds a mobile phone with his hand or holds a mobile phone near to his head; by virtue that frequency shifting is resulted in an environment of high dielectric coefficient, the effect of radiation of a mobile phone may be much lowered, for eliminating such a problem, we propose hereby a brand new design of dual-band loop antenna that not only can directly print an antenna on a dielectric substrate to reduce the cost of manufacturing, but also can have a result of broad band in the vicinity of a GSM band, this can resist large lowering induced by frequency shifting. Wherein the band width of the lower resonant frequency (GSM band) is about 250 MHz (890˜1140 MHz), and the band width of the higher resonant frequency (DCS band) is about 170 MHz, both meet the requirement in application of the actual mobile phone system.

### SUMMARY OF THE INVENTION

As stated above, the object of the present invention is to provide a brand new design of dual-band loop antenna of a mobile phone that not only can get the object of meeting the design of antenna of a mobile phone suiting the bands of GSM (890˜960 MHz)/DCS (1710˜1880 MHz), but also can be directly printed on a dielectric substrate with an advantage of reducing the cost of manufacturing because of the fact that the present invention is structurally simple and is easy for manufacturing.

The antenna of the present invention comprises: a grounding plane, a radiation metallic loop and a radiation metallic plate. The grounding plane, the radiation metallic loop and the radiation metallic plate are all formed by printing or etching on a dielectric substrate. The shape of the grounding plane is generally rectangular having a grounding point and a shorting point; the radiation metallic loop has a feeding end and a shorting end having therebetween a distance smaller than 5 mm, wherein the shorting end is electrically connected to the shorting point on the grounding plane; while the radiation metallic plate is encircled by the radiation metallic loop, and one terminal point of the radiation metallic plate is electrically connected to the vicinity of the shorting end of the radiation metallic loop to be spaced less than 10 mm from the shorting end.

In this designing, a semi-wavelength mode and a full wavelength mode resulted from the resonance of the radiation metallic loop as well as an extra semi-wavelength mode formed by mutual coupling between the radiation metallic plate and the radiation metallic loop together form three resonant modes. The former two resonant modes together form an operational bandwidth of about 250 MHz (890˜1140 MHz) which is close to 3.5 times of the requirement of the GSM band, the return losses in the required band (890˜960 MHz) of the antenna of the present invention are all presented as higher than 7.3 dB that meet the requirement in application. And this designing of antenna not only is simple by structure, but also can be directly formed on a dielectric substrate by adopting the way of printing or etching without the need of an extra process of manufacturing to connect the antenna with a radio-frequency signal line or a system grounding plane; relatively, this is to lower the cost of manufacturing.

The present invention will be apparent in its objects and advantages after reading the detailed description of the preferred embodiment thereof in reference to the accompanying drawings.

### BRIEF DESCRIPTION OF THE DRAWINGS

FIG. 1 is a plane view showing the structure of a first embodiment of the antenna of the present invention;

FIG. 2 is a diagram showing the results of measuring of return losses of the first embodiment of the antenna of the present invention in an experiment;

FIG. 3 is a diagram showing a radiation field type of 960 MHz of the first embodiment of the antenna of the present invention;

FIG. 4 is a diagram showing a radiation field type of 1110 MHz of the first embodiment of the antenna of the present invention;

FIG. 5 is a diagram showing a radiation field type of 1780 MHz of the first embodiment of the antenna of the present invention;

FIG. 6 is a plane view showing the structure of a second embodiment of the antenna of the present invention;

FIG. 7 is a plane view showing the structure of a third embodiment of the antenna of the present invention.

### DETAILED DESCRIPTION OF THE PREFERRED EMBODIMENT

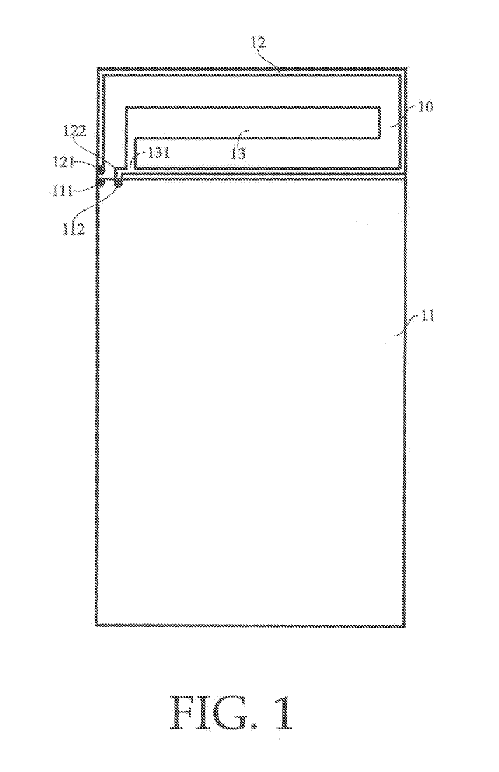

Referring to FIG. 1 showing the structure of a first embodiment of the antenna of the present invention, the first embodiment of the antenna of the present invention comprises: a grounding plane 11, a radiation metallic loop 12 and a radiation metallic plate 13. The grounding plane 11, the radiation metallic loop 12 and the radiation metallic plate 13 are all formed by printing or etching on a dielectric substrate 10. The shape of the grounding plane 11 is generally rectangular having a grounding point 111 and a shorting point 112; the radiation metallic loop 12 has a feeding end 121 and a shorting end 122 having therebetween a distance smaller than 5 mm, wherein the shorting end 122 is electrically connected to the shorting point 112 on the grounding plane 11; while the radiation metallic plate 13 is encircled by the radiation metallic loop 12, and one terminal point 131 of the radiation metallic plate 13 is electrically connected to the vicinity of the shorting end 122 of the radiation metallic loop 12 to be spaced less than 10 mm from the shorting end 122. When the above stated antenna of the present invention is used in a mobile phone system, the grounding plane 11 is a system grounding plane for an inner electric circuit of the mobile phone system; a systematic module and circuit elements can be allocated thereon.

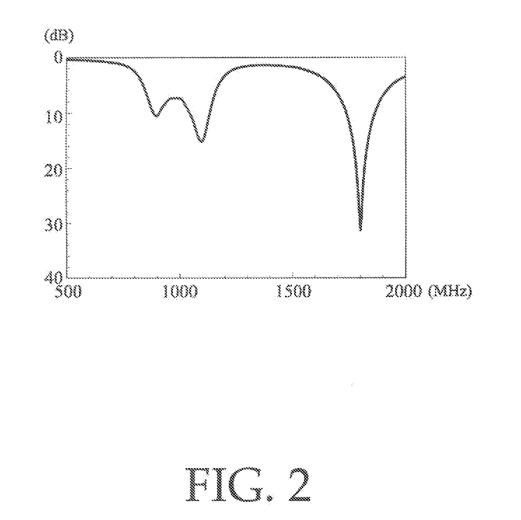

FIG. 2 is a diagram showing the results of measuring of return losses of the first embodiment of the antenna of the present invention in an experiment; the experiment performs measuring after choosing the following sizes: the size of the grounding plane 11 is 50×100 mm², the area of the antenna is 50×15 mm²; the antenna mainly includes a radiation metallic loop 12 and a radiation metallic plate 13. The designing of the antenna is performed by printing or etching, the radiation metallic loop 12 and the radiation metallic plate 13 are formed together with the system grounding plane 11 on a FR4 glass dielectric substrate 10 with a thickness of 0.8 mm; the width of the radiation metallic loop 12 is 0.5 mm, the radiation metallic loop 12 surrounds a rectangular area sized 50×15 mm² having a gross length of 127 mm, one end of the radiation metallic loop 12 is a feeding end 121 of the antenna, the other end is the shorting end 122 that is electrically connected to the grounding plane 11, the feeding end 121 is 1 mm separated from the shorting end 122, and a side of the radiation metallic loop 12 in connecting with the shorting point 112 forms a gap 0.5 mm from the grounding plane 11; the radiation metallic plate 13 is an inversed “L” shaped structure composed of a metallic plate having a length of 4 mm and width of 1 mm as well as a metallic arm having a length of 41 mm and width of 5 mm, an area of the radiation metallic plate 13 in electric connecting with the radiation metallic loop 12 is a distance 2.5 mm away from the shorting end 122 of the radiation metallic loop 12. This antenna has three resonant modes: a semi-wavelength mode and a full wavelength mode resulted from the resonance of the radiation metallic loop 12 as well as an extra semi-wavelength mode formed by mutual coupling between the radiation metallic plate 13 and the radiation metallic loop 12. The former two resonant modes together form an operational bandwidth of about 250 MHz (890˜1140 MHz) which is close to 3.5 times of the requirement of the GSM band (not like the conventional monopole antennas or planar antennas which can cover the GSM band), and the return losses in the required band (890˜960 MHz) of the antenna of the present invention are all presented as higher than 7.3 dB that meet the requirement in application. The third resonant mode covers the requirement of operation for the DCS band, the return losses in the required band (1710˜1880 MHz) within the range of required bands are all presented as higher than 7.3 dB that meet the requirement in application too.

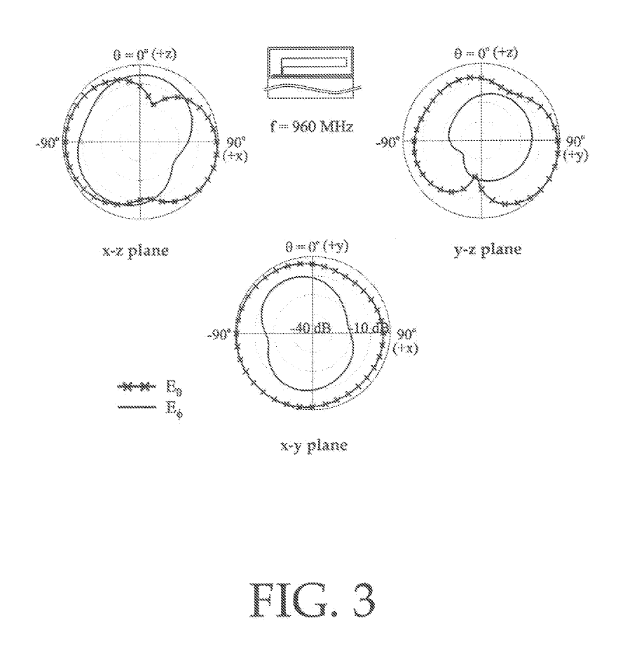

FIG. 3 is a diagram showing a radiation field type of 960 MHz of the first embodiment of the antenna of the present invention; from the result obtained, the radiation field type of the semi-wavelength mode resulted from the resonance of the radiation metallic loop 12 is similar to the radiation field type of the same frequency on a conventional monopole antenna or planar antenna.

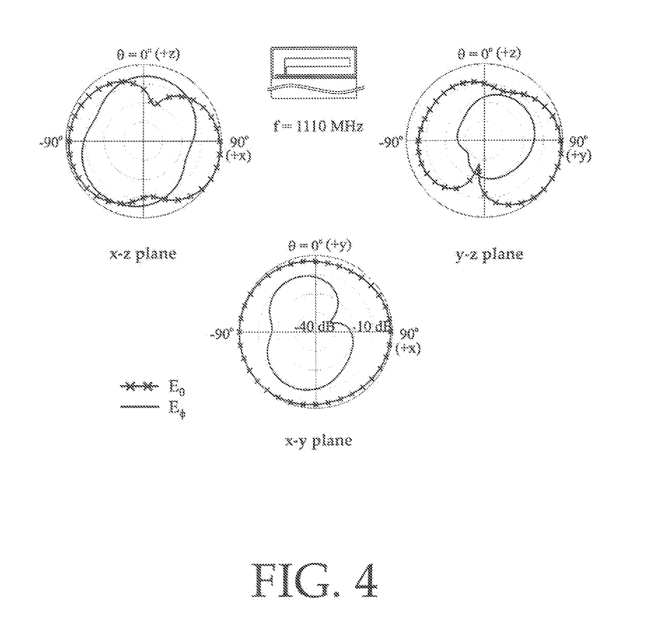

FIG. 4 is a diagram showing a radiation field type of 1110 MHz of the first embodiment of the antenna of the present invention; from the result obtained, the radiation field type of the extra semi-wavelength mode resulted from the resonance of the radiation metallic plate 13 is similar to the radiation field type of the same frequency on a conventional monopole antenna or planar antenna, they are all donut shaped radiation field types.

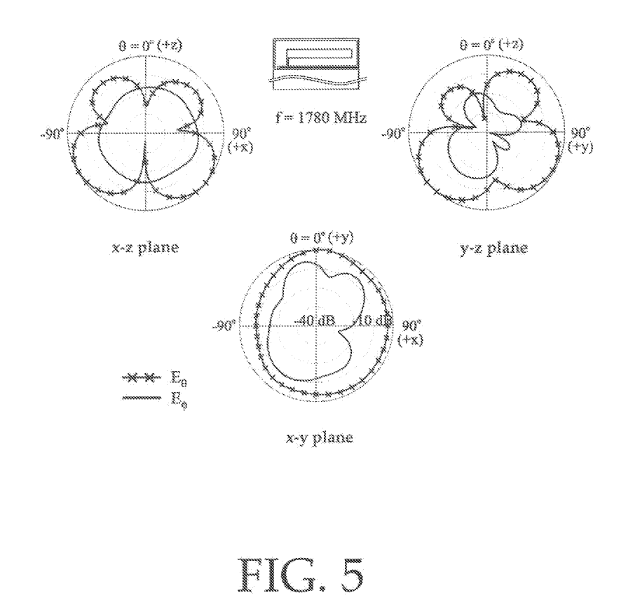

FIG. 5 is a diagram showing a radiation field type of 1780 MHz of the first embodiment of the antenna of the present invention; from the result obtained, the radiation field type of the full wavelength mode resulted from the resonance of the radiation metallic loop 12 is influenced by the zero point of electric current on the grounding plane 11 to have a pair of recessed points in an x-y plane, but this does not influence the requirement for the actual application.

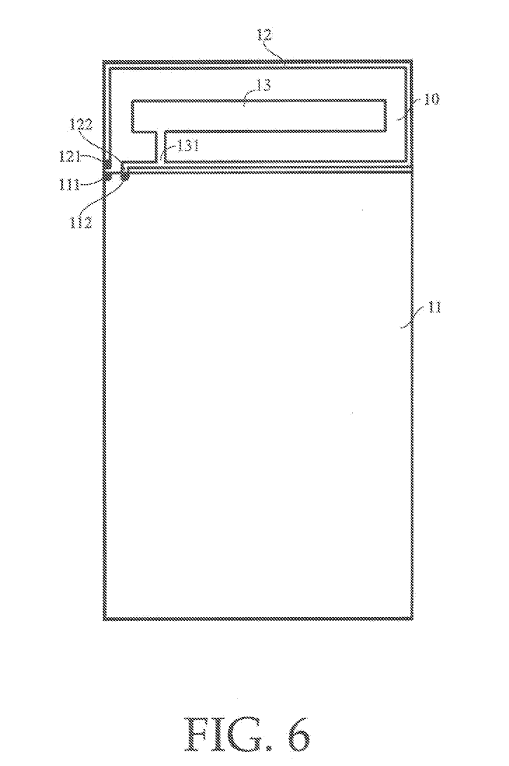

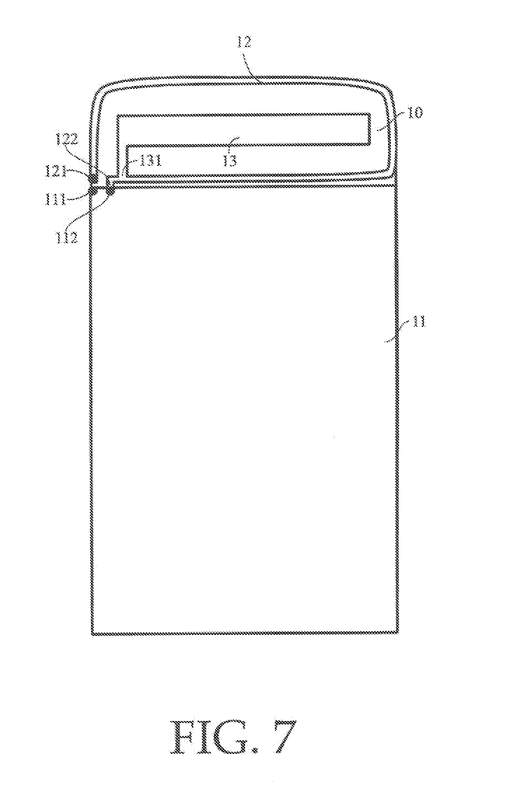

FIGS. 6 and 7 are plane views showing the structure of a second embodiment and a third embodiment respectively of the antenna of the present invention; the second embodiment of FIG. 6 is same in its structure generally as that of the first embodiment, but the radiation metallic plate 13 is a dissymmetrical T shaped structure; the third embodiment of FIG. 7 is also same in its structure generally as that of the first embodiment, but the radiation metallic loop 12 is in the shape of a rectangle with rounded corners or of a smooth curve. The second and the third embodiments each can obtain three resonant modes without a hitch, and can have the same effect as that of the first embodiment.

The result of the experiment of the present invention shows that, the embodiments of the present invention can provide designing for antennas of mobile phones suiting the bands of GSM (890˜960 MHz)/DCS (1710˜1880 MHz), and can have a result of broad band in the vicinity of a GSM band. Wherein the broad band with lower resonant frequency (GSM band) is about 250 MHz (890˜1140 MHz), while the broad band with higher resonant frequency (DCS band) is about 170 MHz, both can meet the requirement in application of the actual mobile phone system.

In conclusion, the antenna of the present invention is simple by structure, costs low in manufacturing and has definite functions; thereby the antenna of the present invention is highly valuable in industrial application and thus is patentable.

The preferred embodiments disclosed above are only for illustrating the present invention. It will be apparent to those skilled in this art that various equivalent modifications or changes made to the elements of the present invention without departing from the spirit of this invention shall fall within the scope of the appended claims and are intended to form part of this invention.

1. A dual-band loop antenna comprising:
a grounding plane being generally rectangular and having a grounding point and a shorting point;
a radiation metallic loop having a feeding end and a shorting end, said feeding end and said shorting end have therebetween a predetermined distance, wherein said shorting end is electrically connected to said shorting point on said grounding plane; and
a radiation metallic plate being encircled by said radiation metallic loop, and one terminal point of said radiation metallic plate is electrically connected to the vicinity of said shorting end of said radiation metallic loop to be spaced less than 10 mm from said shorting end; and
said grounding plane, said radiation metallic loop and said radiation metallic plate are all formed by printing on a dielectric substrate.

2. The dual-band loop antenna as defined in claim 1, wherein said feeding end and said shorting end of said radiation metallic loop have therebetween a predetermined distance smaller than 5 mm.

3. (canceled)

4. The dual-band loop antenna as defined in claim 1, wherein said grounding plane is a system grounding plane for an inner electric circuit of a mobile phone system.

5. The dual-band loop antenna as defined in claim 1, wherein said radiation metallic plate is in an inversed “L” shape.

6. The dual-band loop antenna as defined in claim 1, wherein said radiation metallic plate is in a dissymmetrical T shape.
